(19) United States
(12) Patent Application Publication
(10) Pub. No.: US 2006/0231200 A1
(43) Pub. Date: Oct. 19, 2006

(54) Conductive ball mounting apparatus

(75) Inventor: Kazuo Niizuma, Kanazawa-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIBUYA KOGYO CO., LTD

(21) Appl. No.: 11/400,180

(22) Filed: Apr. 10, 2006

(30) Foreign Application Priority Data
Apr. 15, 2005 (JP) P2005-117805

(51) Int. Cl. B29C 65/00; B32B 37/00; B32B 38/00

(52) U.S. Cl. 156/285; 156/282; 156/292

(57) ABSTRACT

A conductive ball mounting apparatus for mounting conductive balls after an adhesive material was applied to individual electrodes formed in a predetermined array pattern on a mounting target adopts the following means is provided. Firstly, the conductive ball mounting apparatus comprises a stage for placing the mounting target, application means for applying the adhesive material to the electrodes of the mounting target placed on the stage, conductive ball mounting means for mounting the conductive balls at positions, to which the adhesive material has been applied, and transfer means for forming a transfer passage for passing the application means and the conductive ball mounting means. Secondly, the stage is disposed over the transfer means through moving means in a direction perpendicular to the transfer direction by the transfer means, and through turning means and vertically moving means.

This application is based on Japanese Patent Application No. 2005-117805, which is incorporated herein by reference.

### BACKGROUND OF THE INVENTION

1. Field of the Invention

The present invention relates to an improvement in a conductive ball mounting apparatus and, more particularly, is developed mainly on drive means for a stage to mount a mounting target, in a conductive ball mounting apparatus for mounting conductive balls after an adhesive material was applied to individual electrodes formed in a predetermined array pattern on a mounting target.

2. Description of the Related Art

As the conductive ball mounting apparatus for mounting conductive balls after the adhesive material was applied to individual electrodes formed in a predetermined array pattern on the mounting target, there exists in the related art an apparatus for mounting the conductive balls, after sucked, arrayed and adsorbed by the ball mounting head having an array plate, on the individual electrodes on the mounting target, as disclosed in JP-A-2001-358451. However, as the mounting target product such as a wafer becomes larger, the number of solder balls to be mounted at one time exceeds one million. This makes it difficult at present to reduce the defects in the array of solder balls and the defects at the mounting time.

As disclosed in JP-A-2002-538970, therefore, there has been provided an apparatus, in which an electronic substrate or a mounting target printed with flux is provided with an array mask and in which solder balls are directly dropped onto electrodes of the electronic substrate. In this apparatus, however, the flux printing device and the solder balls mounting device are individually required to have Y-axis moving means, Z-axis moving means and θ-axis moving means for the array mask.

### SUMMARY OF THE INVENTION

The present invention has an object to provide a conductive ball mounting apparatus for mounting conductive balls after an adhesive material was applied to individual electrodes formed in a predetermined array pattern on a mounting target. In this apparatus, a stage made movable on a transfer passage in an X-axis direction (or a transfer direction) for mounting a mounting target is equipped with Y-axis (a direction perpendicular to the transfer direction) moving means, Z-axis (a vertical direction) moving means and θ-axis (a turning direction) moving means. The Y-axis moving means, the Z-axis moving means and θ-axis moving means of an array mask needed in the related art individually for the flux printing apparatus and the conductive ball mounting apparatus are eliminated so that the number of component parts of the conductive ball mounting apparatus can be reduced to prevent the apparatus from being large-sized and to mount many conductive balls precisely.

In order to solve the aforementioned problem, a first aspect of the invention adopts the following means in the conductive ball mounting apparatus for mounting conductive balls after an adhesive material was applied to individual electrodes formed in a predetermined array pattern on a mounting target:

Firstly, the conductive ball mounting apparatus comprises a stage for placing the mounting target, application means for applying the adhesive material to the electrodes of the mounting target placed on the stage, conductive ball mounting means for mounting the conductive balls at positions, to which the adhesive material has been applied, and transfer means for forming a transfer passage for passing the application means and the conductive ball mounting means.

Secondly, the stage is disposed over the transfer means through moving means in a direction perpendicular to the transfer direction by the transfer means, and through turning means and vertically moving means.

According to a second aspect of the invention, the conductive ball mounting means mounts the conductive balls by arranging an array mask having through holes formed along with the predetermined array pattern of the electrode for receiving the conductive balls, over the mounting target, and by moving a ball reservoir housing a number of conductive balls, along the upper face of the array mask thereby to drop the conductive balls into the individual through holes.

According to a third aspect of the invention, the conductive ball mounting means fixes and holds the array mask.

According to a fourth aspect of the invention, the conductive ball mounting apparatus further comprises positioning means for positioning the array mask and the mounting target.

In the first aspect of the invention, the stage for mounting the mounting target is disposed over the transfer means through moving means in a direction perpendicular to the transfer direction by the transfer means, and through turning means and vertically moving means. Therefore, the application means for applying the adhesive material and the ball mounting means do not need any of the Y-axis moving means, the Z-axis moving means and the θ-axis moving means additionally so that the conductive ball mounting apparatus can be prevented from being large-sized.

In the second aspect of the invention, the conductive ball mounting means mounts the conductive balls by arranging an array mask having through holes formed in the predetermined array pattern of the electrode for receiving the conductive balls, and by moving a ball reservoir housing a number of conductive balls, along the upper face of the array mask thereby to drop the conductive balls into the individual through holes. It is, therefore, possible to mount such many conductive balls precisely as have accompanied the enlarged size of the mounting target product such as the wafer.

In the third aspect of the invention, the conductive ball mounting means fixes and holds the array mask. In the fourth aspect of the invention, the conductive ball mounting apparatus further comprises positioning means for positioning the array mask and the mounting target. According to either of these aspects of the inventions, it is possible to improve the precision in the conductive ball mounting action.

### BRIEF DESCRIPTION OF THE DRAWINGS

FIG. 1 is a schematic top plan view showing the entirety of a solder ball mounting apparatus according to the embodiment;

FIG. 2 is a schematic top plan view of the case, in which a wafer feeding unit and a wafer housing unit are disposed in the same direction;

FIG. 3 is a partially sectional, explanatory side elevation showing a ball mounting unit;

FIG. 4 is a top plan view of the ball mounting unit; and

FIG. 5 is a front elevation showing the movement of a wafer transfer stage.

### DETAILED DESCRIPTION OF THE PREFERRED EMBODIMENTS

An embodiment of the invention is described in the following with reference to the accompanying drawings. In the invention, a semiconductor wafer (as will be simplified into the wafer), an electronic circuit substrate or a ceramic substrate is exemplified as a target for mounting conductive balls, but a wafer 14 is used in the embodiment. Moreover, flux, solder paste or a conductive adhesive is used as an adhesive material.

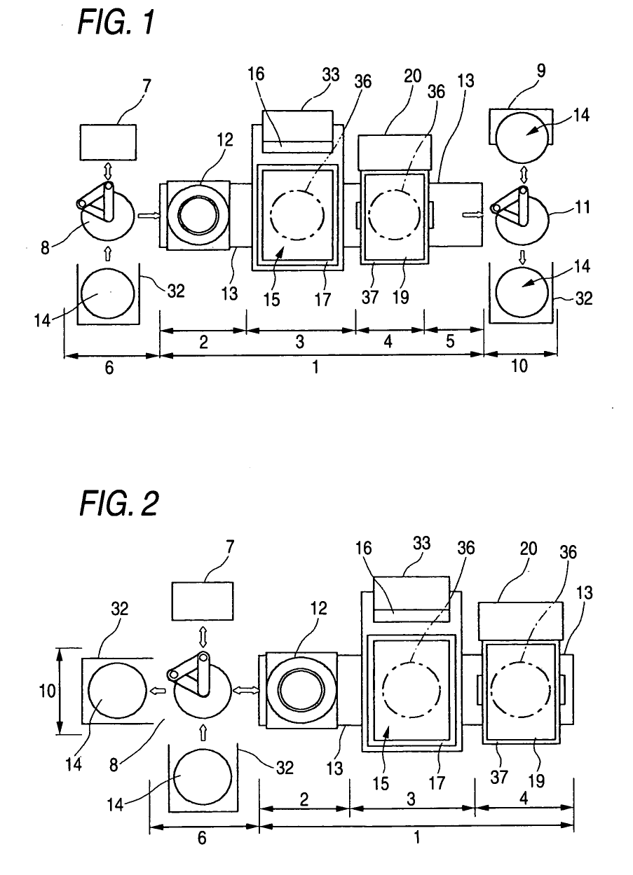

FIG. 1 is a schematic top plan view showing the entirety of a solder ball mounting apparatus 1. This solder ball mounting apparatus 1 includes a carry-in wafer transfer unit 2, a flux printing unit 3, a ball mounting unit 4, and a carry-out wafer transfer unit 5. A wafer feeding unit 6, a primary alignment unit 7 and a carry-in robot 8 exist at the pre-step of the solder ball mounting apparatus 1, and an inversion unit 9, a wafer housing unit 10 and a carry-out robot 11 exist at the post-step of the solder ball mounting apparatus 1.

The primary alignment unit 7 for the pre-step turns the wafer 14 in a horizontal plane to detect the position of an orientation flat or notch of the wafer 14 thereby to correct the position of the wafer 14 approximately and to direct the wafer 14 to be mounted on the wafer transfer unit 2, in a predetermined direction. On the other hand, the inversion unit 9 for the post-step turns the wafer 14 in the horizontal direction so that the wafer 14 is turned to bring its orientation flat or notch to a predetermined position and is housed in a magazine 32.

The solder ball mounting apparatus 1 is equipped with a wafer transfer stage 12 and a transfer passage 13 for transferring the wafer 14 from the wafer transfer unit to the flux printing unit 3, the ball mounting unit 4 and the wafer transfer unit 5. The transfer passage 13 is equipped with an X-axis (longitudinal, as shown) feeding device of the transfer stage 12.

The flux printing unit 3 is equipped with a flux feeding device 16, a printing mask 15 for printing flux or the adhesive material on the wafer 14, and vertical observation cameras 31 for observing the alignment marks of the wafer 14 and the printing mask 15 thereby to register the wafer 14 and the printing mask 15. The printing mask 15 has through holes formed along with the pattern of the electrodes on the wafer 14. Two (not-shown) alignment marks are formed at two portions on the lower face of the printing mask 15 in a through hole forming area 36. The printing mask 15 is applied to a molding box 17 and is held by a fixing unit such as a frame. The flux feeding device 16 moves the (not-shown) squeezee along the upper face of the printing mask 15 so that the flux is printed in the through holes of the printing mask 15 and fed onto the electrodes of the wafer 14. Here, numeral 33 in the drawing designates a cleaning unit for cleaning off the flux adhered to the printing mask 15.

The ball mounting unit 4 is equipped with a solder ball feeding device 20, a ball array mask 19 having through holes 18 formed along with the pattern of the electrodes on the wafer 14, and vertical observation cameras 34 for observing the alignment marks of the wafer 14 and the ball array mask 19 thereby to register them.

The ball array mask 19 has a thickness substantially equal to the diameter of solder balls 21 to be fed, and the through holes 18 have a diameter slightly larger than that of the solder balls. Like the printing mask 15, the ball array mask 19 has the (not-shown) alignment marks formed at two portions on the lower face of the through hole forming area 36. The ball array mask 19 is adhered to a molding box 37 and is held by a fixing unit such as the frame.

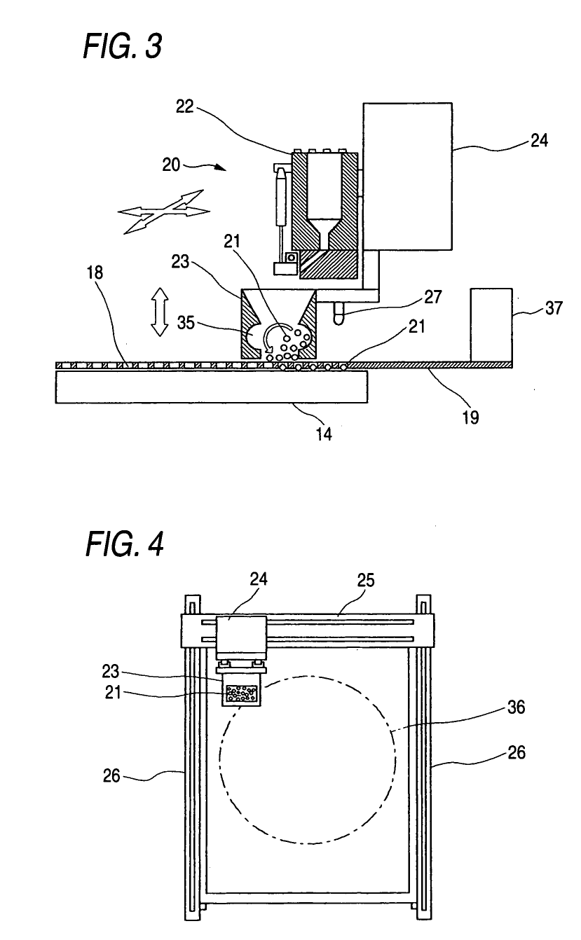

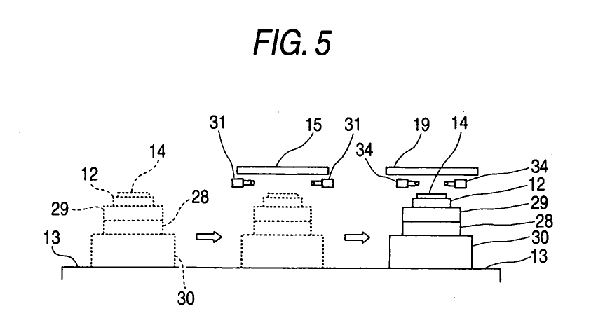

The solder ball feeding device 20 is equipped with a ball hopper 22 for reserving a number of solder balls 21, a ball cup 23 for dropping the solder balls 21 into the ball array mask 19, a mask height detecting sensor 27, and a carriage unit 24 not only for moving the ball cups 23 along an X-axis guide 25 and a Y-axis guide 26 but also for displacing the same in a Z-axis direction. Here, the ball hopper 22 is exchanged according to the size and material of the solder balls 21. Inside of and in the lower portion of the inner wall face of the ball cup 23, there is formed a recess 35 for causing the solder balls 21 housed therein to circulate, as indicated by an arrow in the ball cup 23 in FIG. 3.

The mask height detecting sensor 27 may be of either the contact type or the non-contact type. Specifically, a laser sensor or an electrostatic capacity sensor is used as the mask height detecting sensor 27. The mask height detection is made by bringing the molding box 37 of the ball array mask 19, when exchanged at an initial setting time or at a mold exchanging time, into abutment against a stopper or the like, and by positioning and fixing the molding box 37 by means of a clamp. Specifically, after the ball array mask 19 was fixed, the ball cup 23 empty of the solder balls 21 is moved sequentially on a plurality of height detection points preset outside of the through hole forming area 36, and the height of the upper face of the ball array mask 19 is measured.

On the other hand, the height of the upper face of the ball array mask 19 in the through hole forming area 36 is determined by calculations. Moreover, the heights at the individual positions are calculated by considering the weight which is applied when the solder balls 21 are housed in the ball cup 23. At the ball mounting time, the ball cup 23 is so moved on the basis of the determined height, while being controlled by the moving unit 24, that the clearance between the upper face of the ball array mask 19 and the lower face of the ball cup 23 may not exceed a predetermined distance.

The wafer transfer stage 12 is a stage for placing the wafer 14 thereon and is so mounted on the transfer passage 13 that it can move in the X-axis direction. The wafer transfer stage 12 is equipped with a Y-axis drive mechanism 28 acting as moving means in the direction (i.e. the Y-axis direction) perpendicular to the transfer direction of the wafer 14, a θ-axis drive mechanism 29 acting as turning means, and a Z-axis drive mechanism 30 acting as vertically moving means.

The actions of the solder ball mounting apparatus 1 of the embodiment are described. At first, the wafer 14 to have the solder balls 21 mounted thereon is housed in the magazine 32 of the wafer feeding unit 6. Then, one wafer 14 is extracted from the magazine 32 of the wafer feeding unit 6 and carried in the primary alignment unit 7. In this primary alignment unit 7, the wafer 14 is turned to detect the position of the orientation flat or notch thereby to correct the position of the wafer 14 approximately and to set the orientation flat or notch at a predetermined position. Subsequently, the wafer 14 is carried by the carry-in robot 8 from the primary alignment unit 7 to the wafer transfer stage 12 on standby at the wafer transfer unit 2.

The wafer transfer stage 12 having the wafer 14 mounted thereon moves along the transfer passage 13 to the flux printing unit 3 and stops at a predetermined position. Here, the alignment marks of the wafer 14 and the printing mask 15 are individually observed by the vertical observation cameras 31 so that the wafer transfer stage 12 is positioned in the X-axis direction by the X-axis drive mechanism of the transfer passage 13, in the Y-axis direction by the Y-axis drive mechanism 28 and in the θ-axis direction by the θ-axis drive mechanism 29. After positioned, the wafer transfer stage 12 is raised by the Z-axis drive mechanism 30 so that it is stopped at a predetermined height position with respect to the printing mask 15 having been prepared with the flux. In this state, the printing mask 15 is fed with the flux at its one end portion in the Y-axis direction, and the squeezee is moved toward the other end portion to print the flux on the electrodes of the wafer 14 from the through holes of the printing mask 15.

After the flux-printing, the wafer transfer stage 12 is moved downward by the Z-axis drive mechanism 30 and is moved to the ball mounting unit 4 by the transfer passage 13 so that it is stopped at a predetermined position. Here, the alignment marks of the wafer 14 and the ball array mask 19 are also individually observed by the vertical observation cameras 34, and the wafer transfer stage 12 is positioned in the X-axis direction by the X-axis drive mechanism of the transfer passage 13, and in the Y-axis direction and in the θ-axis direction by the Y-axis drive mechanism 28 and the θ-axis drive mechanism 29, respectively. After this, the wafer transfer stage 12 is moved upward by the Z-axis drive mechanism 30 so that it is stopped while leaving the predetermined clearance from the ball array mask 19.

As shown in FIG. 3, the ball cup 23 moves over the ball array mask 19 to drop the solder balls 21 into the through holes 18 of the ball array mask 19 so that the solder balls 21 are mounted on the wafer 14. After this ball dropping operation, the ball array mask 19 is finely moved horizontally (in the X-axis direction and in the Y-axis direction) with respect to the wafer transfer stage 12 thereby to correct the positions of the solder balls 21 in the through holes 18.

After the solder balls mounting operation, the wafer transfer stage 12 is moved downward by the Z-axis drive mechanism 30 so that it is moved to stop at the carry-out wafer transfer unit. In the wafer housing unit 10, the wafer 14 is transferred from the wafer transfer stage 12 to the inversion unit 9 by the carry-out robot 11, and the wafer 14 is turned to bring the orientation flat or notch to the predetermined position. The wafer 14 is further transferred by the carry-out robot 11 from the inversion unit 9 to the magazine 32 of the wafer housing unit 10. When the carry-out robot 11 takes out the wafer 14 from the wafer transfer stage 12, the wafer transfer stage 12 returns to the original position or the wafer transfer unit 2, thus completing one step. The present apparatus repeats the actions thus far described.

In the embodiment shown in FIG. 1, the wafer feeding unit 6 is disposed in front of the solder ball mounting apparatus 1, and the wafer housing unit 10 is disposed at the back. Since the wafer transfer stage 12 returns to the original position, as described above, the wafer feeding unit 6 and the wafer housing unit 10 may also be disposed on one side, as shown in FIG. 2.

With the structure thus made, the carry-out robot 11 can be replaced by the carry-in robot 8, and the wafer 14 is held and housed in the same direction as that of the wafer 14 being carried in, so that the inversion unit 9 can be omitted. Moreover, one of the wafer transfer units 2 and 5 can also be omitted so that the number of structural components can be reduced. Moreover, this embodiment employs the vertical observation cameras 31 and 34 for photographing the alignment marks of the wafer 14 and the printing mask 15 or the ball array mask 19 simultaneously at the stop time of the wafer transfer stage 12, as the means for positioning the printing mask 15 and the ball array mask 19, and the wafer 14. However, the invention should not be limited thereto but can be conceived to have various structures.

What is claimed is:

1. A conductive ball mounting apparatus comprising:
a stage for placing a mounting target;
application means for applying an adhesive material to an electrode of the mounting target placed on the stage, the electrode being formed in a predetermined array pattern on the mounting target;
conductive ball mounting means for mounting a conductive ball at a position, to which the adhesive material has been applied; and
transfer means for forming a transfer passage for passing the application means and the conductive ball mounting means,
wherein the stage is disposed over the transfer means through moving means in a direction perpendicular to the transfer direction by the transfer means, and through turning means and vertically moving means.

2. The conductive ball mounting apparatus according to claim 1, wherein the conductive ball mounting means mounts the conductive ball by the steps of:
arranging an array mask having a through hole formed along with the predetermined array pattern of the electrode for receiving the conductive ball, over the mounting target; and
moving a ball reservoir housing a number of conductive balls, along an upper face of the array mask thereby to drop the conductive balls into individual through holes.

3. The conductive ball mounting apparatus according to claim 1, wherein the conductive ball mounting means fixes and holds the array mask.

4. The conductive ball mounting apparatus according to claim 1, further comprising positioning means for positioning the array mask and the mounting target.
